(19) United States
(12) Patent Application Publication
(10) Pub. No.: US 2019/0213876 A1
(43) Pub. Date: Jul. 11, 2019

(54) IMAGE DISTRIBUTION DEVICE, IMAGE DISTRIBUTION METHOD, AND STORAGE MEDIUM STORING IMAGE DISTRIBUTION PROGRAM

(71) Applicant: Toyota Jidosha Kabushiki Kaisha, Toyota-shi Aichi-ken (JP)

(72) Inventors: Yoshinori Yamada, Nagakute-shi Aichi-ken (JP); Takahiro Suzuki, Nagoya-shi Aichi-ken (JP); Yosuke Tokuda, Ota-ku Tokyo-to (JP); Taiki Nakamura, Toyota-shi Aichi-ken (JP); Miyu Tanaka, Miyoshi-shi Aichi-ken (JP); Kentaro Otokubo, Nagoya-shi Aichi-ken (JP)

(21) Appl. No.: 16/241,213

(22) Filed: Jan. 7, 2019

(30) Foreign Application Priority Data
Jan. 10, 2018 (JP) 2018-001786

(51) Int. Cl. G08G 1/01; G06K 9/00; H04W 4/46; H04W 4/44

(52) U.S. Cl. CPC G08G 1/0141; G08G 1/0112; H04W 4/44; H04W 4/46; G06K 9/00791

(57) ABSTRACT

An image distribution device includes: a receiving section that receives a captured image captured by a first vehicle and position information relating to a position where the captured image has been captured; an identification section that identifies one or more second vehicles that are different from the first vehicle and that are heading toward the position indicated by the position information received by the receiving section; and a transmission section that transmits the captured image received by the receiving section to the one or more second vehicles identified by the identification section.

### CROSS-REFERENCE TO RELATED APPLICATION

This application is based on and claims priority under 35 USC 119 from Japanese Patent Application No. 2018-001786 filed on Jan. 10, 2018, the disclosure of which is incorporated by reference herein.

### BACKGROUND

### Technical Field

The present disclosure relates to an image distribution device, an image distribution method, and a storage medium storing an image distribution program.

### Related Art

In recent times, vehicles are being installed with imaging devices such as cameras, and store situations encountered while driving and driving operations. Storing situations encountered while driving and driving operations is useful for ascertaining the circumstances when accidents and the like occur. There have been various proposals regarding vehicles installed with imaging devices.

For example, Japanese Patent Application Laid-Open (JP-A) No. 2011-28651 discloses a vehicle video recording device that stores video captured by an imaging device on arrival of the vehicle at a location where caution is preferably urged during travel. The vehicle video recording device of JP-A No. 2011-28651 also enables the situation to be ascertained in cases other than traffic accidents, when driving at a location where caution is urged.

However, the above vehicle video recording device does not anticipate the use of recorded video by anyone other than a driver driving the vehicle. There is room for improvement with regard to utilizing such recorded video in the road-using community.

### SUMMARY

In consideration of the above circumstances, the present disclosure provides an image distribution device, an image distribution method, and a non-transitory storage medium storing an image distribution program, enabling captured images captured by a particular vehicle to be utilized in the road-using community.

A first aspect of the present disclosure is an image distribution device including a receiving section that receives a captured image captured by a first vehicle and position information relating to a position where the captured image has been captured; an identification section that identifies one or more second vehicles that are different from the first vehicle and that are heading toward the position indicated by the position information received by the receiving section; and a transmission section that transmits the captured image received by the receiving section to the one or more second vehicles identified by the identification section.

In the first aspect, a captured image captured by the first vehicle is transmitted to the one or more second vehicles heading toward the position where the captured image has been captured. Users of the second vehicles may thus be notified in advance of the situation at a scene witnessed by a user of the first vehicle. For example, if the captured image is an image of the scene of a broken-down vehicle, the users of the second vehicles are able to ascertain in advance that there is a lane restriction or traffic jam as a result of the broken-down vehicle.

The first aspect may be configured such that the one or more second vehicles identified by the identification section are each a vehicle traveling at a predetermined speed or lower.

In the above configuration, the one or more vehicles traveling at a predetermined speed or lower are identified to be recipients of the captured image, and the captured image is not transmitted to any vehicles traveling faster than the predetermined speed. Users traveling at high speed are thus not distracted by the captured image, enabling safety to be secured.

The first aspect may be configured such that the one or more second vehicles include a vehicle traveling in an oncoming traffic lane in the opposite direction to a traffic lane indicated by the position information.

In the above configuration, the captured image is also distributed to vehicles traveling in the oncoming traffic lane, enabling users of the second vehicles traveling in the oncoming traffic lane to be prevented from making sideways glances while driving.

The first aspect may be configured so as to further include a decision section that determines a report recipient according to an incident causing traffic obstruction appearing in the captured image; and a reporting section that reports to the report recipient determined by the decision section.

In the above configuration, the report recipient is decided in accordance with the incident causing traffic obstruction appearing in the captured image, so as to report to appropriate recipients. This thereby assists the appropriate authorities and so on with implementing a swift response to the incident causing traffic obstruction.

The first aspect may be configured such that the transmission section varies a target amongst the one or more second vehicles identified by the identification section for transmission of the captured image according to a severity level of the incident causing traffic obstruction.

In the above configuration, the captured image may be selectively transmitted to vehicles affected by the incident causing traffic obstruction according to the severity level of the incident causing traffic obstruction.

A second aspect of the present disclosure is an image distribution method including receiving a captured image captured by a first vehicle and position information relating to a position where the captured image has been captured; identifying one or more second vehicles heading toward the position indicated by the position information; and transmitting the captured image to the one or more identified second vehicles.

A third aspect of the present disclosure is a non-transitory storage medium storing a program that causes a computer to execute image distribution processing, the image distribution processing including: receiving a captured image captured by a first vehicle and position information relating to a position where the captured image has been captured; identifying one or more second vehicles heading toward the position indicated by the position information; and transmitting the captured image to the one or more identified second vehicles.

In the present disclosure, a captured image captured by the first vehicle is transmitted to the one or more second vehicles heading toward the position where the captured image has been captured. Captured images captured by the first vehicle may therefore be utilized in the road-using community, including the one or more second vehicles that are different from the first vehicle.

### BRIEF DESCRIPTION OF THE DRAWINGS

Exemplary embodiments of the present invention will be described in detail based on the following figures, wherein:

FIG. 1 is a diagram illustrating schematic configuration of an image distribution system according to an exemplary embodiment;

FIG. 2 is a block diagram illustrating hardware configuration of an onboard device;

FIG. 3 is a block diagram illustrating hardware configuration of an image distribution device;

FIG. 4 is a block diagram illustrating an example of functional configuration of the image distribution device;

FIG. 5 is a flowchart illustrating a flow of operation of the onboard device;

FIG. 6 is a flowchart illustrating a flow of processing of the image distribution device; and

FIG. 7 is a flowchart illustrating a flow of operation of the onboard device.

### DETAILED DESCRIPTION

Explanation follows regarding an example of an exemplary embodiment of the present disclosure, with reference to the drawings. Note that the same or equivalent configuration elements and sections are allocated the same reference numerals in each of the drawings. In the drawings, the scale may be exaggerated to aid explanation and thus may differ from actual dimensions.

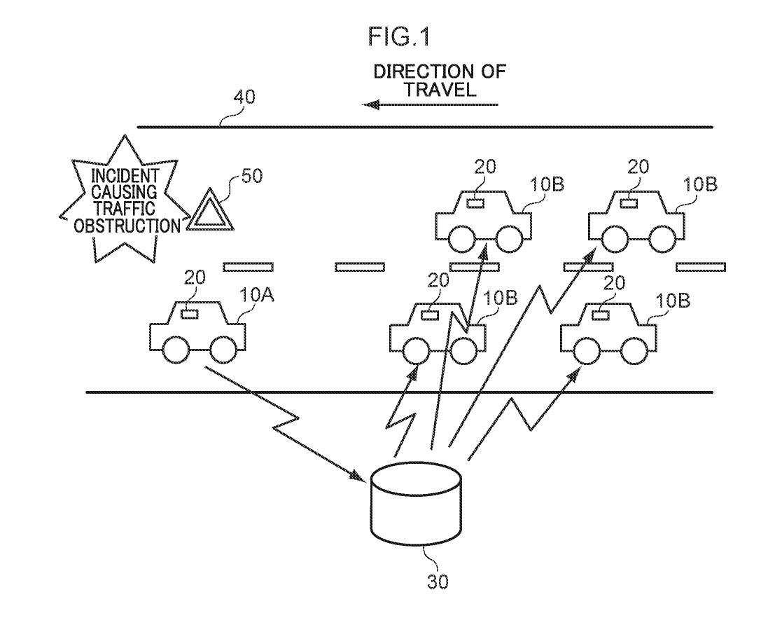

FIG. 1 is a diagram illustrating a schematic configuration of an image distribution system according to the exemplary embodiment.

As illustrated in FIG. 1, the image distribution system includes onboard devices 20 that are installed in plural vehicles 10, and an image distribution device 30 that is capable of communicating with the plural onboard devices 20.

In the exemplary embodiment, explanation is given regarding an example in which, as illustrated in FIG. 1, the plural vehicles 10 are traveling along a road 40 in the same direction as each other. In FIG. 1, for ease of explanation, each vehicle 10 is labeled either as a vehicle 10A or a vehicle 10B. Where the vehicle 10A and the vehicles 10B are not distinguished, they are referred to as the vehicles 10.

Each onboard device 20 transmits various information regarding the vehicle 10 in which it is installed to the image distribution device 30. In the exemplary embodiment, the vehicle 10A is the first vehicle 10 to pass close to the scene of an incident causing traffic obstruction. The vehicles 10B are vehicles 10 that pass close to the scene of the incident causing traffic obstruction after the vehicle 10A. Note that in the present specification, “close to” may include not only the scene itself, but also locations that are close enough for a user driving the vehicle 10 to be able to see the scene of the obstruction causing incident, such as a location in an oncoming lane on the other side of the road.

The onboard device 20 of the vehicle 10A includes an imaging section, which captures an image of the scene of an accident. The onboard device 20 transmits the captured image to the image distribution device 30. Specific configuration and operation of the onboard device 20 will be described later.

The image distribution device 30 transmits the image transmitted from the onboard device 20 of the vehicle 10A to the onboard devices 20 of the vehicles 10B following behind. Specific configuration and operation of the image distribution device 30 will be described later.

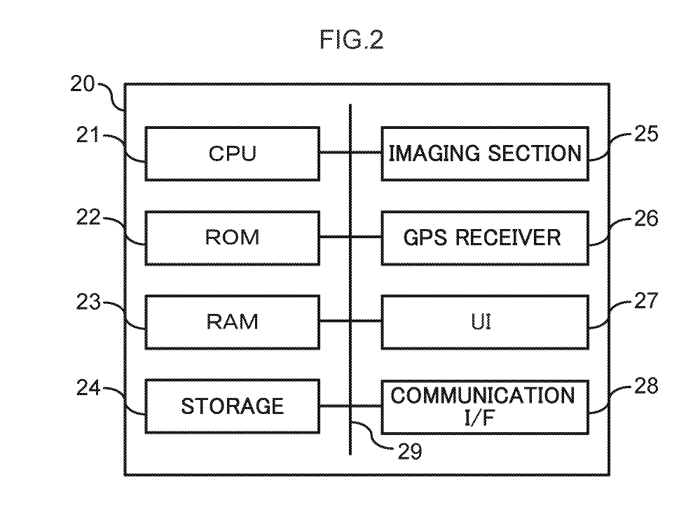

FIG. 2 is a block diagram illustrating a hardware configuration of the onboard device.

As illustrated in FIG. 2, each onboard device 20 includes a central processing unit (CPU) 21, read only memory (ROM) 22, random access memory (RAM) 23, storage 24, an imaging section 25, a GPS receiver 26, a user interface (UI) 27, and a communication interface (I/F) 28. These configurations are connected together so as to be capable of communicating through a bus 29.

The CPU 21 is a central computation processing unit that executes various programs and controls various sections. Namely, the CPU 21 reads programs from the ROM 22 or the storage 24, and executes the programs using the RAM 23 as a workspace. The CPU 21 controls the various configurations and performs various computation processing according to the programs recorded in the ROM 22 or the storage 24. In the exemplary embodiment, an image transmission program to transmit images captured by the imaging section, and an image display program to display images distributed by the image distribution device 30 are stored in the ROM 22 or the storage 24.

The ROM 22 stores various programs and various data. The RAM 23 serves as a workspace that temporarily retains programs and data. The storage 24 is configured by a hard disk drive (HDD) or a solid state drive (SSD), and stores various programs including an operating system, and various data.

The imaging section 25 captures images of the vehicle surroundings from the vehicle 10. For example, the imaging section 25 includes a CCD image sensor, a CMOS image sensor, a MOS image sensor, or the like. The GPS receiver 26 receives GPS signals from plural satellites, and identifies the position of the vehicle 10 (or onboard device 20) based on an arrival time lag between these signals.

The UI 27 is an interface employed when a user onboard the vehicle 10 uses the onboard device 20. For example, the UI 27 includes at least one of a liquid crystal display equipped with a touch panel capable of being touch-operated by the user, a voice input receiver that receives voice input from the user, or buttons or the like that may be depressed by the user. The communication interface 28 is an interface for communication between the onboard device 20 and the image distribution device 30 and other devices, and, for example, employs an Ethernet®, FDDI, Wi-Fi®, or other standard.

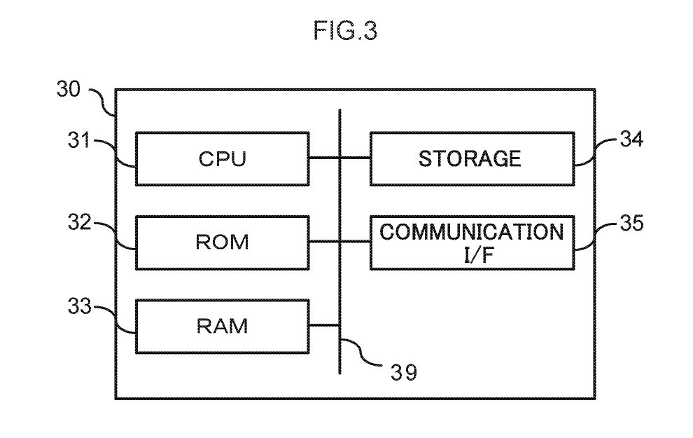

FIG. 3 is a block diagram illustrating a hardware configuration of an image distribution device.

As illustrated in FIG. 3, the image distribution device 30 includes a CPU 31, ROM 32, RAM 33, storage 34, and a communication interface 35. These configurations are connected together so as to be capable of communicating through a bus 39. The image distribution device 30 is configured by a server.

The CPU 31 is a central computation processing unit that executes various programs and controls various sections. Namely, the CPU 31 reads programs from the ROM 32 or the storage 34, and executes the programs using the RAM 33 as a workspace. The CPU 31 controls the various configurations and performs various computation processing according to the programs recorded in the ROM 32 or the storage 34. In the exemplary embodiment, an image distribution program to distribute captured images received from an onboard device 20 is stored in the ROM 32 or the storage 34.

The ROM 32 stores various programs and various data. The RAM 33 serves as a workspace that temporarily retains programs and data. The storage 34 is configured by an HDD or an SSD, and stores various programs including an operating system, and various data. The communication interface 35 is an interface for communication between the image distribution device 30 and the onboard devices 20 and other devices, and, for example, employs an Ethernet®, FDDI, Wi-Fi®, or other standard.

When executing the image distribution program, the image distribution device 30 implements various functions employing the above hardware resources. Explanation follows regarding functional configurations implemented by the image distribution device 30.

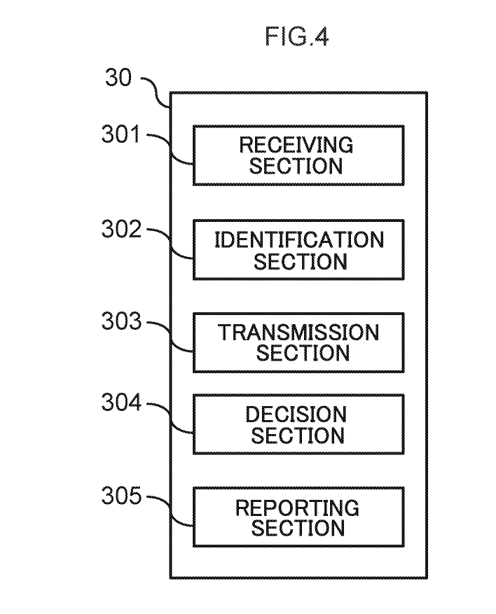

FIG. 4 is a block diagram illustrating an example of functional configuration of the image distribution device.

As illustrated in FIG. 4, the functional configuration of the image distribution device 30 includes a receiving section 301, an identification section 302, a transmission section 303, a decision section 304, and a reporting section 305. Each functional configuration is implemented by the CPU 31 reading and executing the image distribution program retained in the ROM 32 or the storage 34.

The receiving section 301 receives a captured image captured by the vehicle 10A (i.e., first vehicle), as well as position information relating to the position where the captured image has been captured.

The identification section 302 identifies one or more vehicles 10B (i.e., second vehicles) that are different vehicles from the vehicle 10A and that are heading toward the position indicated by the position information received by the receiving section 301. More specifically, the identification section 302 may identify vehicles 10B that are vehicles traveling at a predetermined speed or lower.

The transmission section 303 transmits the captured image received by the receiving section 301 to the vehicles 10B identified by the identification section 302.

The decision section 304 determines a report recipient according to an incident causing traffic obstruction that appears in the captured image.

The reporting section 305 reports to the report recipient determined by the decision section 304.

Next, explanation follows regarding operation of the onboard devices 20 and the image distribution device 30. In order to keep the operation in chronological order, explanation follows regarding operation of the onboard device 20, followed by explanation regarding operation of the image distribution device 30, and then returns to explanation regarding operation of the onboard device 20. The first onboard device 20 to be described is the onboard device 20 that transmits a captured image to the image distribution device 30. Namely, operation of the onboard device 20 installed to the vehicle 10A in the example of FIG. 1 is described first. The onboard device 20 that is described later is the onboard device 20 to which a captured image is distributed from the image distribution device 30. Namely, the final explanation is regarding operation of an onboard device 20 installed in any one of vehicles 10B in the example of FIG. 1.

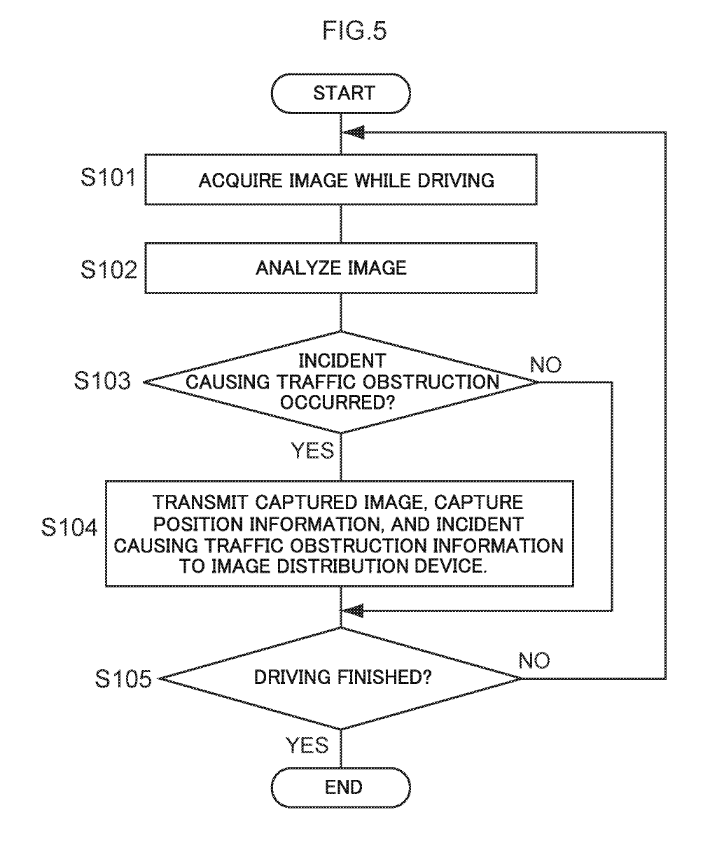

FIG. 5 is a flowchart illustrating a flow of operation of the first onboard device 20. The CPU 21 of the first onboard device 20 reads the image transmission program in order to execute the processing of the first onboard device 20.

When a user starts driving the vehicle 10, the CPU 21 starts imaging the vehicle surroundings using the imaging section 25 at step S101.

The CPU 21 analyzes the images captured by the imaging section 25 at step S102. For example, the CPU 21 analyzes features in the captured images and performs matching with image features corresponding to an incident causing traffic obstruction concerning the vehicle 10. An incident causing traffic obstruction is an incident that causes travel of the vehicle 10 to be obstructed, and that could affect driving by the user of the vehicle 10, and is also an event that the user is able to see. Examples of incidents causing traffic obstruction on the road 40 include traffic accidents, stationary broken-down vehicles, fallen objects on the road, fallen rocks on the road, road surface collapse, landslides, dead animals on the road, lane restrictions due to construction work, and the like. The CPU 21 determines whether or not features appearing in the captured images captured during travel of the vehicle 10 correspond to features that appear in captured images when an incident causing traffic obstruction has been captured. For example, in the event that an accident has occurred or a stationary broken-down vehicle is present, a warning triangle 50 is placed on the road 40 as illustrated in FIG. 1. The CPU 21 learns features corresponding to a warning triangle 50 in advance, and if features corresponding to a warning triangle 50 appear in an actual image captured by the imaging section 25, the CPU 21 identifies that an accident or vehicle breakdown has occurred. Features corresponding to lane restrictions due to construction work or the like may be extracted from signs indicating the lane restrictions. The occurrence of fallen objects, fallen rocks, and dead animals may likewise be identified by learning features appearing in images in advance. The above learnt features are merely examples, and any features that may be obtained when capturing images of the scene of an incident causing traffic obstruction may be extracted and applied in the exemplary embodiment.

At step S103, the CPU 21 determines whether or not an incident causing traffic obstruction has occurred based on an analysis result of step S102.

In cases in which an incident causing traffic obstruction has not occurred, i.e., negative determination is made in step S103, the CPU 21 proceeds to the processing of step S105. In cases in which an incident causing traffic obstruction has occurred, i.e., positive determination is made in step S103, at step S104, the CPU 21 transmits to the image distribution device 30 the captured image that has been used to determine that an incident causing traffic obstruction has occurred, position information indicating the position of the vehicle 10 when the captured image has been captured, as identified by the GPS receiver 26, and information indicating the incident causing traffic obstruction.

At step S105, the CPU 21 determines whether or not the user has finished driving the vehicle 10. In cases in which driving has not finished, i.e., negative determination is made in step S105, the CPU 21 repeats the processing from step S101. In cases in which driving has finished, i.e., positive determination is made in step S105, the CPU 21 ends the processing based on the image transmission program.

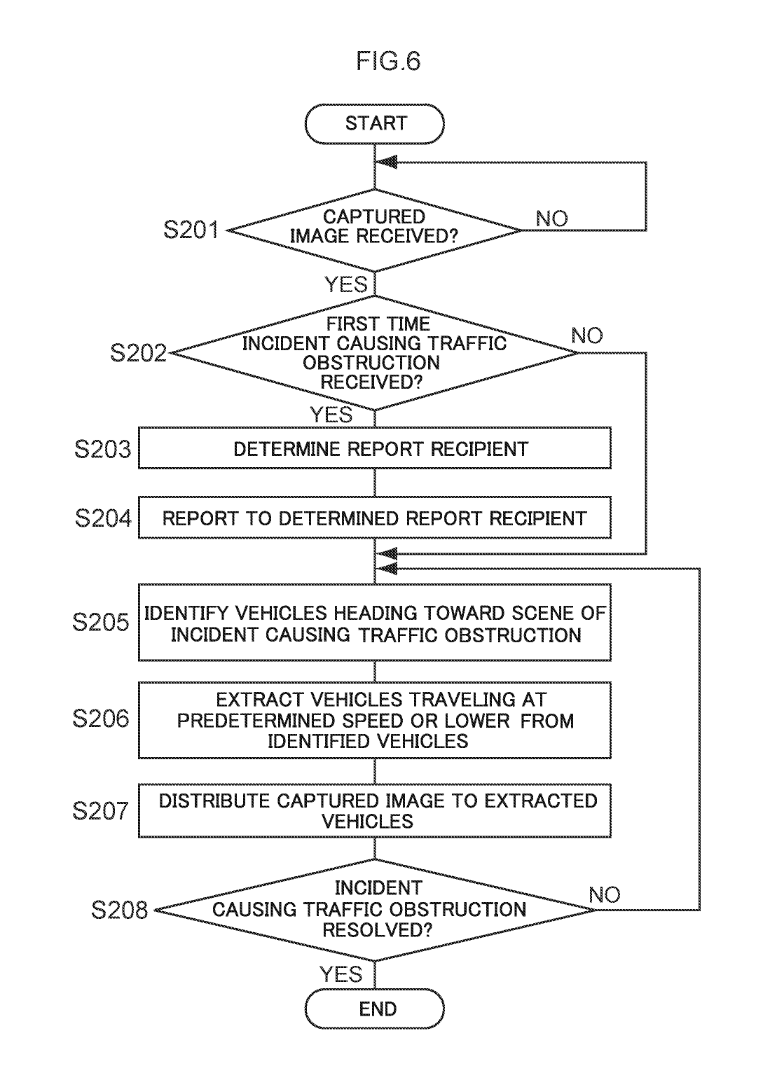

FIG. 6 is a flowchart illustrating a flow of processing by the image distribution device. The CPU 31 of the image distribution device 30 loads the image distribution program in order to execute the processing of the image distribution device 30.

At step S201, the CPU 31 determines whether or not a captured image, position information, and information indicating an incident causing traffic obstruction has been received from any of the vehicles 10. In cases in which a captured image has not been received, i.e., negative determination is made in step S201, the CPU 31 stands by until a captured image is received. In cases in which a captured image has been received, i.e., positive determination is made in step S201, at step S202, the CPU 31 determines whether or not this is the first time the incident causing traffic obstruction has been received. The “first time the incident causing traffic obstruction has been received” refers to the earliest time an incident causing traffic obstruction is received by the image distribution device 30 in cases in which the image distribution device 30 receives multiple reports of an incident at the same location and the same time. For example, if rocks happen to fall at the same location on separate days, each rock fall is regarded as a separate incident causing traffic obstruction.

In cases in which this is not the first time the incident causing traffic obstruction has been received, i.e., negative determination is made in step S202, the CPU 31 proceeds to the processing of step S205. In cases in which this is the first time the incident causing traffic obstruction has been received, i.e., positive determination is made in step S202, at step S203, the CPU 31 determines a report recipient based on the incident causing traffic obstruction, according to the incident causing traffic obstruction that appears in the captured image. The incident causing traffic obstruction that appears in the captured image may be ascertained from information indicating the incident causing traffic obstruction received at step S201. For example, in cases in which the incident causing traffic obstruction that has occurred is a traffic accident, at step S204, the CPU 31 reports the location and time of the incident causing traffic obstruction, details of the incident causing traffic obstruction, and so on to the emergency services in order to dispatch an ambulance and fire truck, or a police officer. When this is performed, the CPU 31 may transmit the captured image to the report recipient. Moreover, for example, if the incident causing traffic obstruction is a fallen rock, the CPU 31 reports this to the local authority or transport authority. The report recipients may be set as appropriate according to the rules of the relevant local administration.

At step S205, the CPU 31 identifies vehicles 10B heading toward the scene of the incident causing traffic obstruction. The CPU 31 communicates with plural vehicles 10 through the communication interface 35, and acquires position information and car navigation information from each vehicle 10 so as to enable identification of vehicles 10 heading toward the scene of the incident causing traffic obstruction. The vehicles 10 identified here include any vehicles 10 that are approaching the scene of the incident causing traffic obstruction, and include not only vehicles 10 traveling in a traffic lane indicated by the position information received at step S201 (a lane in which the location indicated by the position information is present), but also vehicles 10 traveling in the opposite direction in an oncoming traffic lane.

At step S206, the CPU 31 extracts (identifies) vehicles 10B traveling at a speed of a predetermined speed or lower from the vehicles 10B identified at step S205. The predetermined speed is, for example, 40 km/hr, 30 km/hr, 20 km/hr, and the like. The predetermined speed may be set to an appropriate speed in consideration of safety when driving.

At step S207, the CPU 31 distributes the captured image received from the onboard device 20 at step S201 to any vehicles 10B extracted at step S206 as an image of the scene where the incident causing traffic obstruction has occurred. At step S208, the CPU 31 determines whether or not the incident causing traffic obstruction has been resolved. Determination as to whether or not the incident causing traffic obstruction has been resolved may, for example, be made by acquiring information from a road traffic information communication system. Alternatively, the CPU 31 may cause any one vehicle 10B to which the image of the scene has been distributed at step S207 to capture and transmit an image as the vehicle 10B passes the scene of the incident causing traffic obstruction, and then analyze the received captured image to determine whether or not the incident causing traffic obstruction is ongoing or has ended.

In cases in which the incident causing traffic obstruction has not been resolved, i.e., negative determination is made in step S208, the CPU 31 returns to the processing of step S205. In cases in which the incident causing traffic obstruction has been resolved, i.e., positive determination is made in step S208, the CPU 31 ends the processing based on the image distribution program.

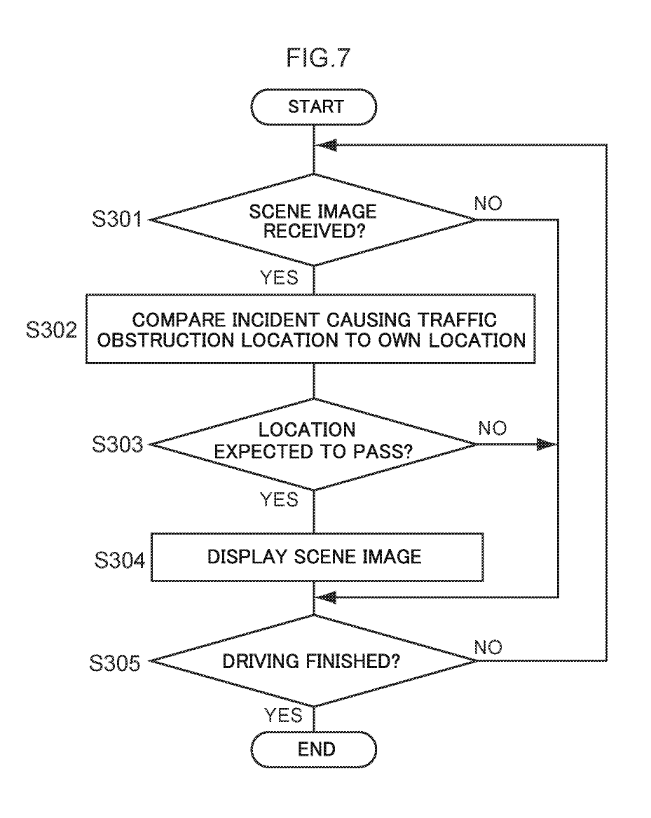

FIG. 7 is a flowchart illustrating a flow of operation of the second onboard device 20. The CPU 21 of the second onboard device 20 loads the image display program in order to execute the processing of the second onboard device 20.

At step S301, the CPU 21 determines whether or not a scene image, distributed by the image distribution device 30 at step S207 in FIG. 6, has been received. In cases in which a scene image has not been received, i.e., negative determination is made in step S301, the CPU 21 proceeds to the processing of step S305. The image of the scene is accompanied by position information indicating the location of the incident causing traffic obstruction and information indicating the incident causing traffic obstruction.

In cases in which a scene image has been received, i.e., positive determination is made in step S301, at step S302, the CPU 21 compares the position information indicating the location of the incident causing traffic obstruction with its own position information identified using the GPS receiver 26.

At step S303, the CPU 21 determines whether or not the vehicle 10 in which the onboard device 20 itself is installed is expected to pass close to the location of the incident causing traffic obstruction. In cases in which the vehicle 10 is not expected to pass close to the location of the incident causing traffic obstruction, i.e., negative determination is made in step S303, the CPU 21 proceeds to the processing of step S305. In cases in which the vehicle 10 is expected to pass close to the location of the incident causing traffic obstruction, i.e., positive determination is made in step S303, at step S304, the CPU 21 displays the scene image received at step S301. That is, the CPU 21 displays the scene image using the UI 27 of the second onboard device 20.

At step S305, the CPU 21 determines whether or not the user has finished driving the vehicle 10. In cases in which driving has not finished, i.e., negative determination is made in step S305, the CPU 21 repeats the processing from step S301. In cases in which driving has finished, i.e., positive determination is made in step S305, the CPU 21 ends the processing based on the image display program.

As described above, the image distribution device 30 according to the exemplary embodiment transmits a captured image captured by the first onboard device 20 of the leading vehicle 10A to the second onboard devices 20 of any vehicles 10B heading toward the position imaged in the captured image. The users of these vehicles 10B may thus be notified in advance of the situation at the scene of the incident causing traffic obstruction witnessed by the vehicle 10A. For example, if the scene image is an image of the scene of a broken-down vehicle, the users of these vehicles 103 are able to ascertain in advance that there is a lane restriction or traffic jam as a result of the broken-down vehicle. Since the users may be informed in advance of the situation at the scene of the incident causing traffic obstruction, the likelihood of sideways glances from users attempting to catch a glimpse of the situation at the scene while driving as they pass close to the actual scene may be reduced, enabling safety to be improved. Moreover, even if a traffic jam has occurred due to the incident causing traffic obstruction, users of the vehicles 10B may be informed of the incident causing the traffic jam in advance, affording them some degree of acceptance.

The image distribution device 30 extracts any vehicles 10B traveling at the predetermined speed or lower from the vehicles 10B heading toward the scene of the incident causing traffic obstruction, and distributes the captured image (image of the scene) to these vehicles 10B. This enables a configuration in which the captured image is not transmitted to any vehicles 10 traveling at high speed. Users traveling at high speed are thus not distracted by the captured image, enabling safety to be secured.

Moreover, the scene image is distributed not only to vehicles 10B traveling in the traffic lane included in the scene where the incident causing traffic obstruction has occurred, but also to vehicles 10B traveling in an oncoming traffic lane. This thereby enables users of vehicles 10 traveling in the oncoming traffic lane to be prevented from making sideways glances while driving.

Moreover, the image distribution device 30 determines the report recipient according to the incident causing traffic obstruction that appears in the captured image so as to report to appropriate recipients. This thereby assists the appropriate authorities and so on with implementing a swift response to the incident causing traffic obstruction.

Explanation has been given regarding an image distribution system of the present exemplary embodiment. However, the present disclosure is not limited to the above exemplary embodiment, and various improvements or modifications are possible.

For example, some of the processing in the flowcharts illustrated in FIG. 5 to FIG. 7 may be transferred from the onboard device 20 to the image distribution device 30, or may be transferred from the image distribution device 30 to the onboard device 20. For example, the image analysis at step S102 executed by the first onboard device 20 may be executed by the image distribution device 30.

Moreover, some of the processing in the flowcharts illustrated in FIG. 5 to FIG. 7 may be omitted. For example, the reporting function may be omitted from the processing of the image distribution device 30. In such cases, step S202 to step S204 are omitted. Moreover, in the processing of the image distribution device 30, the scene image may be transmitted to all vehicles 10B heading toward the scene of the incident causing traffic obstruction, regardless of the speed at which the vehicles 10B are traveling. In such cases, step S206 is omitted.

Moreover, in the above exemplary embodiment, explanation has been given regarding a configuration in which the scene image is distributed to vehicles 10 that are heading toward the scene of the incident causing traffic obstruction and that are traveling at the predetermined speed or lower. However, there is no limitation thereto. For example, among the vehicles 10 heading toward the scene, the distribution targets of the scene image of the incident causing traffic obstruction may be varied depending on the severity level of the incident causing traffic obstruction. The severity level of the incident causing traffic obstruction is, for example, a value proportional to the time until the incident causing traffic obstruction is likely to be resolved. The longer the resolution time, the greater the severity level. Incidents causing traffic obstruction with a high severity level include, for example, landslides and fallen rocks. Incidents causing traffic obstruction such as stationary broken-down vehicles and fallen objects on the road are more easily resolved than landslides or the like, and are thus set with a lower severity level. The image distribution device 30 determines the severity level according to the incident causing traffic obstruction that appears in the captured image, and varies the distribution targets of the captured image for higher severity levels such that the captured image is also distributed to vehicles 10 that are a long way from the scene of the incident causing traffic obstruction.

Moreover, FIG. 7 only illustrates a configuration in which a scene image of the incident is displayed. However, for example, configuration may be made such that the travel speed of the vehicle 10B is identified by its onboard device 20, and the scene image is displayed in cases in which the vehicle 10B is at the predetermined speed or lower, whereas audio giving details of the incident causing traffic obstruction is presented in cases in which the vehicle 10B is traveling faster than the predetermined speed. Alternatively, a user may be allowed to select either display of a scene image or presentation of audio. Moreover, configuration may be made in which text giving details of the incident causing traffic obstruction is presented instead of displaying the scene image of the incident.

The functions of the image distribution device 30 may be amalgamated with those of the onboard device 20. In such cases, the onboard device 20 serves as the image distribution device 30.

Note that the image transmission processing, image distribution processing, and the display processing read from software (programs) and executed by the CPUs 21, 31 in the above exemplary embodiment may be executed by various processors other than a CPU. Examples of such processors include a programmable logic device (PLD) in which circuit configuration may be modified post-manufacture, such as a field-programmable gate array (FPGA), or a specialized electric circuit that is a processor with a specifically-designed circuit configuration for executing specific processing, such as an application specific integrated circuit (ASIC). The image transmission processing, the image distribution processing, and the display processing may be executed by a single one of such processors, or may be executed by a combination of two or more processors of the same type or different types (for example, by plural FPGAs, or a combination of a CPU and an FPGA). More specific examples of hardware structures of such processors include electric circuits configured by combining circuit elements such as semiconductor devices.

In the above exemplary embodiment, explanation has been given regarding a mode in which the image transmission program, the image distribution program, and the image display program are retained (installed) in advance in the ROM 32 or the storage 34; however, there is no limitation thereto. The programs may be provided in a format stored in a storage medium such as compact disc read only memory (CD-ROM), digital versatile disc read only memory (DVD-ROM), or universal serial bus (USB) memory. Alternatively, these programs may be provided in a format downloaded from an external device through a network.

What is claimed is:

1. An image distribution device comprising:
memory; and
a processor connected to the memory, the processor being configured to:
receive a captured image captured by a first vehicle and position information relating to a position where the captured image has been captured;
identify one or more second vehicles that are different from the first vehicle and that are heading toward the position indicated by the received position information; and
transmit the received captured image to the one or more identified second vehicles.

2. The image distribution device of claim 1, wherein the processor is configured to identify a vehicle traveling at a predetermined speed or lower as the one or more second vehicles.

3. The image distribution device of claim 1, wherein the processor is configured to identify the one or more second vehicles including a vehicle traveling in an oncoming traffic lane in the opposite direction to a traffic lane indicated by the position information.

4. The image distribution device of claim 1, wherein the processor is further configured to:
determine a report recipient according to an incident causing traffic obstruction appearing in the captured image; and
report to the determined report recipient.

5. The image distribution device of claim 4, wherein the processor is configured to vary a target amongst the identified one or more second vehicles for transmission of the captured image according to a severity level of the incident causing traffic obstruction.

6. An image distribution method comprising:
receiving a captured image captured by a first vehicle and position information relating to a position where the captured image has been captured;
identifying one or more second vehicles heading toward the position indicated by the position information; and
transmitting the captured image to the one or more identified second vehicles.

7. A non-transitory storage medium storing a program that causes a computer to execute image distribution processing, the image distribution processing comprising:
receiving a captured image captured by a first vehicle and position information relating to a position where the captured image has been captured;
identifying one or more second vehicles heading toward the position indicated by the position information; and
transmitting the captured image to the one or more identified second vehicles.
